(19) United States
(12) Patent Application Publication
(10) Pub. No.: US 2008/0284443 A1
(43) Pub. Date: Nov. 20, 2008

(54) Method for scientific research

(76) Inventor: Alexander Shekhtman, Tustin, CA (US)

Correspondence Address: Alexander Z. Shekhtman, 15711 Williams St. # 186, Tustin, CA, 92780, US

(21) Appl. No.: 12/152,892

(22) Filed: May 19, 2008

Related U.S. Application Data
(60) Provisional application No. 60/930,675, filed on May 18, 2007.

(51) Int. Cl. G01N 27/416

(52) U.S. Cl. 324/426

(57) ABSTRACT

A method providing comprehensive information about the properties of a type of electrochemical batteries at all stages of batteries resource exhaustion at their utilization which (properties) are connected with the action of the corresponding (for this utilization) influence on the batteries is realized through acquisition of the experimental data that contains the comprehensive information about these properties, creation of the known and new relevant quantities (on the basis of the acquired experimental data and some relevant parameters of the batteries) that characterize these properties, and study of the functional behavior of the created relevant quantities.

### FIELD OF THE INVENTION

This invention relates to methods of scientific research.

### BACKGROUND OF THE INVENTION

One of the main goals of the intensive research method (IRM)/A. Z. Shekhtman, Russian Patent No. 2037917 (1991); A. Z. Shekhtman, in Meeting Abstracts, the 210th Meeting of the Electrochemical Society, Cancun 2006, abstract No. 1843/is comprehensive research of the properties of a system that are connected with an action of a chosen influence on the system and can be observed in the framework of a chosen parameter of this influence (the influence “strength”), parameters of the response and capabilities of the measuring instruments used. IRM doesn't directly research the content and the structure of a researched system, it studies the processes occurring in the researched system within the framework indicated above.

IRM includes acquisition of the experimental data that contains comprehensive information about the properties of a system, creation of the known and new relevant quantities (functions of the time, the influence “strength”, and response parameters that characterize these properties) on the basis of this data and some parameters of the researched system, and comprehensive research of the properties of the system through the study of functional behavior of the created relevant quantities.

The acquisition of the experimental data in the main version of IRM for research of an individual system consists of carrying out a specific pattern of influences and pauses (the value of the influence “strength” is zero in the pauses) for the system and monitoring the parameters of the response of the system during each influence and pause. The specific pattern is characterized by a sequence of short alternating influences and pauses. Each short influence has segments of (or instant) increasing and decreasing influence “strength” and a main segment of the short influence where it has a constant value of the influence “strength”. The influence “strength” of the main segment increases in each subsequent influence after the short pause. The segments of increasing and decreasing influence “strength” have, as a rule, very short durations when technically possible. Very short duration means here that this duration has a time that much less than the expected characteristic times of processes that are planned to research in the system.

The creation of the relevant quantities that characterize from different sides the properties of a researched system includes various mathematical operations over the experimental data and parameters of the researched system and is facilitated by the acquisition of the experimental data occurring during primarily constant influences and pauses (excluding non-essential, very short segments of increasing and decreasing influence).

The comprehensive research of the properties of the system is realized through the study of the functional behavior of the created relevant quantities. Study of functional behavior of the created relevant quantities stimulates emerging new ideas and models of processes in the researched system and simultaneously stimulates creation of new relevant quantities on the basis of the same experimental data and so on recurrently.

Another relevant research method, the intensive research method for a set of identical systems/A. Z. Shekhtman, in Meeting Abstracts, the 199^{th} Meeting of the Electrochemical Society, Washington 2001, abstract No. 1028/, has the same main goals and differs only in the specific pattern of influences and pauses.

In the IRM for a set of identical systems, the specific pattern of influences and pauses is characterized by exposure of each identical system to action of only one short influence of the same form that discussed above with the subsequent short pause but the influence “strength” in the main segment of the short influence has a different value for each identical system.

Both the above-mentioned IRM methods comprehensively characterize the initial state of a researched system or a set of identical systems. However, if a researched system is an object with limited resources for a specific utilization, this information may not be sufficient. We often need to know the properties of the object at different stages of its resource exhaustion as, for example, in the case of the electrochemical batteries.

### OBJECT AND ADVANTAGES OF THE INVENTION

The object and advantage of the current invention is to provide an improved method of research that is capable giving comprehensive information about the properties of a type of electrochemical batteries at all stages of their resource exhaustion at their utilization.

### SUMMARY OF THE INVENTION

The improved method is intended for scientific research. The improved method includes acquisition of the experimental data that contains comprehensive information about the properties of a type of electrochemical batteries at all stages of their resource exhaustion at their utilization; creation of known and new relevant quantities (functions of the time, influence “strength”, resource exhaustion and response parameters) that characterize these properties on the basis of the acquired experimental data and some parameters of the batteries; comprehensive research of these properties through the study of the functional behavior of the created relevant quantities.

### DESCRIPTION OF THE DRAWING

N/A

### DETAILED DESCRIPTION OF THE INVENTION

The improved method is intended to extend advantages of the existing comprehensive research methods to a case where resources of a studied system for a specific utilization are limited and we are interested to know properties of the system at different stages of its resource exhaustion for this utilization.

One of the main goals of the improved method, hereafter named the extended intensive research method (EIRM), is comprehensive research of the properties of a type of electrochemical batteries at all stages of their resource exhaustion at their utilization which (properties) are connected with the action of the corresponding (for this utilization) influence on the batteries and can be observed in the framework of a chosen parameter of this influence (the influence “strength”), parameters of the response and exhaustion, and capabilities of the measuring instruments used.

EIRM includes acquisition of the experimental data (values of the quantities that characterize the experimental conditions, values of the parameter of the influence “strength”, values of the exhaustion parameter, and values of the real time during the influences and the subsequent pauses and the corresponding values of the response for all identical batteries in the researched set of identical batteries and for all researched values of the parameter of their resource exhaustion) that contains comprehensive information about the properties of a type of electrochemical batteries, creation of the known and new relevant quantities (functions of the time, influence “strength”, parameter of exhaustion, and response parameters) on the basis of this experimental data and some relevant parameters of the researched batteries, and comprehensive research of these properties through the study of functional behavior of the created relevant quantities. EIRM doesn't directly research the content and the structure of researched batteries, it studies the processes occurring in them within the framework indicated above.

Acquisition of the experimental data in EIRM consists of recording values of the quantities that characterize experimental conditions, carrying out a specific pattern of discharges and recoveries (the value of the influence “strength” is zero at the recoveries) for each battery in a set of identical electrochemical batteries, and monitoring and recording parameters of the response of each battery to the influence as functions of the real time, parameter of exhaustion, and influence “strength” during each discharge and recovery in the same intervals of time. The said intervals of time are the same for the set, but can be different in different studies. Practically, often, it is sufficient to record the response parameters during a time from the beginning of each discharge and recovery and also at the end of each discharge and recovery.

The specific pattern of the discharges and recoveries in EIRM differs from those in IRMs. Each identical battery is subjected to the action of a sequence of alternating discharges and recoveries. Each sequence has a number of long discharges the duration of which is determined by usage of some part of battery resource. Each sequence also includes a number (the same for all sequences) of short initial discharges and a number (the same for all sequences) of intermediate short discharges between each two neighboring long discharges and after the last one. Each discharge in a sequence has segments of (or instant) increasing and decreasing influence “strength” and a main segment, where the influence “strength” has a constant value which is the same for all discharges of the sequence but different in the different sequences (for different identical batteries of the set of identical batteries). This is the only essential difference between the sequences excluding the duration and the number of the long discharges. The segments of increasing and decreasing influence “strength” have, as a rule, very short durations, when it is technically possible. A recovery in a sequence follows after each discharge. Duration of the recoveries and short discharges must be so small as it possible, but more than the values of the expected characteristic times of the processes that are planning to be researched and must give the possibility to get sufficient number of measurements by the measuring instruments used. A sequence ends when the corresponding battery stops satisfying utilization requirements. Very short duration means here that its time is much less than the expected characteristic times of the processes researched in the batteries.

In EIRM, like in IRMs, creation of the relevant quantities that characterize properties of researched batteries from different sides includes different mathematical operations over the experimental data and parameters of the researched batteries and is facilitated by the acquisition of the experimental data occurring during primarily constant-“strength” influences on the batteries in the discharges and recoveries (excluding non-essential, very short segments of increasing and decreasing influence) that lead to mutual independence of the influence “strength” and time in the created relevant quantities.

Comprehensive research of the properties of researched electrochemical batteries at all stages of their resource exhaustion is realized in EIRM through the study of the functional behavior of the created relevant quantities. Study of the functional behavior of the created relevant quantities stimulates emerging new ideas and models of processes in the researched batteries and simultaneously allows for the creation of new relevant quantities on the basis of the same experimental data and so on.

To illustrate applications of the method, let us consider a specific case of its application. In this case, the discharges of researched electrochemical batteries and the influences on them are realized by the connection of the batteries to external resistive loads. As a parameter of the influence (the influence “strength”), we choose 1/R where R is the electrical resistance of an external resistive load. As parameters of the response, we can consider the polarization, H, of the batteries (the difference between the voltage of a battery at the open circuit and the battery voltage at its discharge in an external load) and the electrical current I through an external resistive load. As a utilization requirement, we can choose, for example, the requirement that the battery voltage at a discharge would be higher than some specific voltage. The battery recoveries after the long discharges (the long influences) serve as marks of specific stages of battery exhaustion. We can choose, for example, the portion of the theoretical resource used by a battery as a parameter of battery exhaustion. The presence of one short initial discharge (the short initial influence) in each sequence of alternating discharges and recoveries gives opportunity to research the initial states of the researched batteries. If we include several short initial discharges with increasing durations (in consecutive order) in each sequence in the same way, we will expand our capabilities in research of the irreversibility index of processes in the batteries. The presence of one intermediate short discharge (the intermediate short influence) between each two neighboring long discharges and after last one in each sequence gives the opportunity to research the states of the researched batteries at all researched degrees of their exhaustion more comprehensively. If we substitute each one of the intermediate short discharges by several ones (alternating with recoveries) with increasing durations in consecutive order in the same way between each two neighboring long discharges and after the last one in each sequence, we will expand our capabilities in research of the irreversibility index of processes in the batteries at all degrees of their exhaustion. The mentioned above irreversibility index is only one of many general characteristics (the relevant quantities) of processes in different researched systems. Among other general characteristics, we can mention the susceptibility indexes of a researched system and the inverse characteristic times of changes in it (the examples of these relevant quantities are correspondingly −R(∂H/∂R)/H and (∂H/∂t)/H in the considered case). On the basis of the experimental data and relevant parameters of the researched systems, we can also create some specific-for-considered-system characteristics (the relevant quantities). We can create new and new relevant quantities on the basis of the same experimental data, a specific data of the researched systems, and different models of processes in the systems.

The previous paragraph shouldn't be construed as a limitation on the scope of the invention, but as exemplification of the main conceptions that follows thereof.

What is claimed is:

1. A comprehensive research method of the properties of a type of electrochemical batteries at all stages of their resource exhaustion at utilization which (properties) are connected with the action of a specific for this utilization influence on the batteries and can be observed in the framework of a chosen parameter of this influence (the influence “strength”), parameters of the response, a parameter of battery exhaustion, and the capabilities of the measuring instruments used including the steps of:
carrying out a sequence of alternating discharges (influences) and recoveries (pauses) for each battery in a set of identical electrochemical batteries, with a number of long discharges the duration of which is determined by usage of some part of battery resource, with a number of initial short discharges and intermediate short discharges in each sequence, with increasing and decreasing influence “strength” in each discharge, with a main segment of each discharge having a constant value of the influence “strength” during the sequence but having different values in the sequences for different identical batteries of the set, with a recovery after each discharge, and with the end of the sequence occurring when the corresponding battery stops satisfying utilization requirements;
monitoring and recording the parameters of the response of the batteries to the influence during each discharge (influence) and each recovery (pause) for each of the batteries of the set;
creating the relevant quantities that could characterize properties of the researched batteries from different sides by means of different mathematical operations over the experimental data and relevant parameters of the batteries;
studying functional behavior of the created relevant quantities as functions of the real time, influence “strength”, utilization parameter, and response parameters;
creating and studying functional behavior of the new relevant quantities.

2. The method of the claim 1, wherein duration of the initial short discharges increases in each next initial short discharge in each sequence in the same way.

3. The method of the claim 1, wherein said number of initial short discharges equals one in each sequence.

4. The method of the claim 1, wherein duration of the intermediate short discharges increases in consecutive order in the same way between each two neighboring long discharges and after the last one in each sequence.

5. The method of the claim 1, wherein the number of intermediate short discharges between each two neighboring long discharges and after the last one equal one in each sequence.

6. The method of the claim 1, wherein said recording occurs during a time from the beginning of each discharge and recovery and also at the end of each discharge and recovery for all identical batteries of the set.
